(19) United States
(12) Patent Application Publication
(10) Pub. No.: US 2025/0274215 A1
(43) Pub. Date: Aug. 28, 2025

(54) DISPERSION COMPENSABLE CWDM MUX

(71) Applicant: II-VI Delaware, Inc., Wilmington, DE (US)

(72) Inventors: Grace Zhang, Wilmington, DE (US); Shuchao Lv, Wilmington, DE (US); Caixia Zhu, Wilmington, DE (US); Sharon Zeng, Wilmington, DE (US)

(21) Appl. No.: 19/053,512

(22) Filed: Feb. 14, 2025

Related U.S. Application Data
(60) Provisional application No. 63/557,332, filed on Feb. 23, 2024.

(51) Int. Cl. H04J 14/02; G02B 6/293; H04B 10/2525

(52) U.S. Cl. CPC H04J 14/0307; G02B 6/2938; H04B 10/2525

(57) ABSTRACT

This disclosure describes a system and method for providing a multiplexer (MUX), with compensable dispersion, that is configurable for course wavelength division multiplexing (CWDM).

### CROSS REFERENCE TO RELATED APPLICATIONS

This application claims priority to and the benefit of U.S. Provisional Patent Application No. 63/557,332 entitled “DISPERSION COMPENSABLE CWDM MUX” filed Feb. 23, 2024, which is hereby incorporated herein by reference in its entirety.

### BACKGROUND

Limitations and disadvantages of a traditional multiplexer (MUX) will become apparent to one of skill in the art, through comparison of such approaches with some aspects of the present method and system set forth in the remainder of this disclosure with reference to the drawings.

### BRIEF SUMMARY

Systems and methods provide a multiplexer (MUX), with compensable dispersion, configurable for course wavelength division multiplexing (CWDM), substantially as illustrated by and/or described in connection with at least one of the figures, as set forth more completely in the claims.

### BRIEF DESCRIPTION OF THE DRAWINGS

FIG. 1 illustrates an example MUX that is operable for CWDM networks, in accordance with various example implementations of this disclosure.

FIG. 2 illustrates an example of AR and HR, in accordance with various example implementations of this disclosure.

### DETAILED DESCRIPTION

The following discussion provides various examples of systems and methods for providing a multiplexer (MUX), with compensable dispersion, configurable for course wavelength division multiplexing (CWDM). Such examples are non-limiting, and the scope of the appended claims should not be limited to the particular examples disclosed. In the following discussion, the terms “example” and “e.g.” are non-limiting.

The figures illustrate the general manner of construction, and descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “or” means any one or more of the items in the list joined by “or”. As an example, “x or y” means any element of the three-element set {(x), (y), (x, y)}. As another example, “x, y, or z” means any element of the seven-element set {(x), (y), (z), (x, y), (x, z), (y, z), (x, y, z)}.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

One of the limitations in long-distance datacenter networking is fiber dispersion, which tends to worsen as distance and/or data rate increase. For example, 100G/lane networks may experience yield loss at a distance of 10 km due to dispersion, while 200 Gb/s per lane (200G/lane) networks suffer from even more significant dispersion.

Wavelength Division Multiplexing (WDM) allows different data streams to be sent simultaneously over a single optical fiber network, with two primary technologies being Coarse Wavelength Division Multiplexing (CWDM) and Dense Wavelength Division Multiplexing (DWDM). CWDM supports up to 18 wavelength channels transmitted over a dark fiber, where each channel's wavelength is spaced 20 nm apart. For instance, the first four channels may be centered at 1270 nm, 1290 nm, 1310 nm, and 1330 nm.

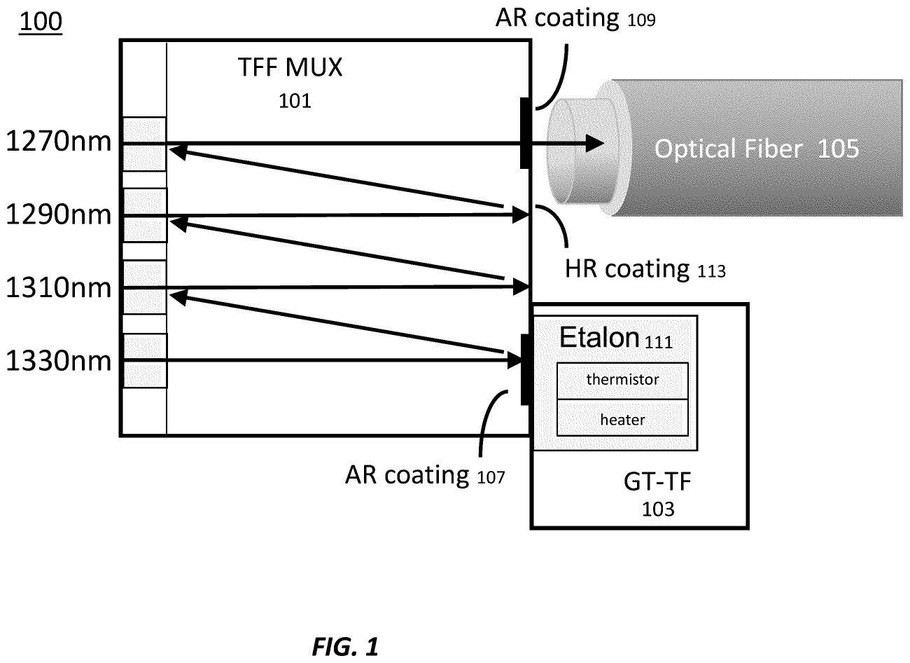

FIG. 1 illustrates an example multiplexer (MUX) 100 that provides compensation for dispersion over an optical fiber 105 in a CWDM network. In this design, several input signals, such as those from the 1270 nm, 1290 nm, 1310 nm, and 1330 nm channels, may share the same fiber. The dispersion-compensable CWDM MUX 100 comprises a thin-film filter (TFF) MUX 101 and a Gires-Tournois tunable filter (GT-TF) 103.

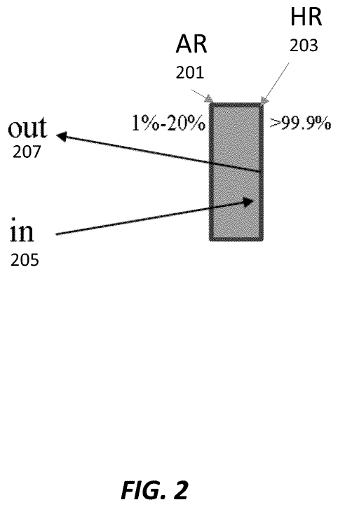

FIG. 2 shows an example of an anti-reflective (AR) coating 201 and a high-reflective (HR) coating 203. In one embodiment, more than 99.9% of an optical input 205 may be reflected off the HR coating, and between 80% and 99% of that reflection may pass through the AR coating 201 to be output as 207.

Returning to FIG. 1, the internal walls of the TFF MUX 101 may comprise an HR coating 113 and two outputs with AR coatings 107 and 109. The AR coating 107 may allow one or more channels (for example, the 1,330 nm channel) to pass to the GT-TF 103 and return to the TFF MUX 101, while AR coating 109 may permit all input channels to be transmitted over fiber 105. The GT-TF 103 may be configured to provide tunable dispersion compensation for one or more channels, such as the 1,330 nm channel. The GT-TF 103 may comprise a single-cavity etalon silicon chip 111 with an HR coating on one side and an adjustable AR coating on the opposite side. Integrated heaters and thermistors on chip 111 may enable spectrum tuning. For example, a control circuit may be configured to continuously monitor an output parameter of the GT-TF. The heater and thermistor may be adjusted in response to ambient temperature variations, thereby maintaining the periodic dispersion spectrum within a predetermined tolerance.

The GT etalon-based tunable filter (TF) 103 exhibits a periodic dispersion spectrum designed to compensate for fiber dispersion. Unlike a normal etalon, the GT etalon-based TF 103 may reflect up to 100% of the optical power across the entire spectrum, thereby compensating for dispersion with little or no power loss. The GT etalon-based tunable filter (TF) 103 may be used in a reflection path. Dispersion, however, is not necessarily constant. Dispersion may exhibit both positive and negative values within one period (the free spectrum range, or FSR). For example, peak dispersion values may reach as high as +27 ps/nm, and an FSR of about 100 GHz may be observed at a temperature cycle of 7° C. The etalon chip 111 is designed to introduce 0 dB of insertion loss (IL), and when combined with a collimator, the added loss may be less than 0.5 dB.

The GT TF 103 may be used on one wavelength or multiple wavelengths. For example, in FIG. 1, only the 1330 nm signal is coupled to the GT TF 103. Dispersion may be fine at 1310 nm and below but bad at 1330 nm.

Manufacturing efficiency is demonstrated by the fact that one 6″ wafer may produce between 5,000 and 6,000 GT-TFs 103. For a 100G/lane application, the GT-TF 103 may be designed with an FSR of 100 GHZ, corresponding to a 414 μm chip thickness. For a 200 Gb/s per lane (200G/lane) application, where the modulated signal is broader, the GT-TF 103 is set to an FSR of 220 GHZ, which corresponds to a chip thickness of 200 μm.

The challenges addressed by this disclosure relate to the lack of dispersion compensation in current CWDM networks. Existing systems are limited by fiber dispersion, with transmission distances significantly reduced as data rates increase. For example, in the 200 Gbps/lane CWDM systems, the transmission reach may be less than 2 km. The inclusion of the GT-TF in the CWDM MUX design provides a novel solution for long-distance data transmission by offering effective dispersion compensation. With this technology, a 200 Gbps/lane CWDM system may achieve transmission distances of up to 10 km.

A key advantage of the disclosed design is the use of a Gires-Tournois etalon-based filter, which is the only verified design for dispersion compensation in this context. The adjustable AR coating in the GT-TF plays a critical role in achieving tunable dispersion compensation. By adjusting the AR coating, different compensation ranges may be achieved. For example, a 15% AR coating may provide a dispersion compensation range of −30 ps/nm to +30 ps/nm, while a 30% AR coating may provide a range of −60 ps/nm to +60 ps/nm.

The periodic dispersion spectrum may compensate for positive and negative dispersion values within a FSR of 220 GHz for a 200 Gb/s per lane (200G/lane) application. The GT-TF may be calibrated by measuring the FSR and/or insertion loss. The heater and thermistor settings may be adjusted according to the calibration results to optimize dispersion compensation for the transmitted wavelength channels, particularly for a 200 Gb/s per lane (200G/lane) application.

Achieving 0 dB insertion loss in the GT-TF design is significant because higher optical power generally results in better signal quality. As data rates increase, systems require more optical power, and maintaining a favorable link budget becomes more challenging, particularly in 200 Gb/s per lane (200G/lane) long-distance transmissions. Although 0 dB insertion loss is the theoretical design target, practical products may achieve less than 0.5 dB, which is highly desirable.

The periodic dispersion spectrum of the GT-TF is characterized by a cosine-shaped curve that comprises both positive and negative dispersion values. This dual nature is important because the CWDM system requires compensation for both positive and negative dispersion. For instance, since the zero-dispersion wavelength is at 1,311 nm, wavelengths below 1,311 nm (such as 1,271 nm) experience negative fiber dispersion and require the TF to provide positive dispersion. Conversely, wavelengths above 1,311 nm (such as 1,331 nm) experience positive fiber dispersion and require negative compensation. When dispersion compensation is required at lower wavelengths, the single GT-TF 103 may be used for multiple wavelengths. Alternatively, a system may comprise multiple GT-TFs, for multiple wavelengths.

Advanced semiconductor processes facilitate the production of 5,000-6,000 GT-TFs on a single 6″ wafer. The design ensures minimal power loss while providing effective dispersion compensation across the FSR by employing a GT-etalon with one side having a 100% HR coating, which may guarantee zero power loss.

This disclosure is particularly beneficial for network configurations operating at 200 Gb/s per lane (200G/lane) and higher speeds, making it ideally suited for high-speed transmission systems. Conventional solutions do not adopt dispersion compensation and fail to maintain a link beyond 10 km in 200 Gb/s per lane (200G/lane) systems. In conventional solutions, the signal quality degrades significantly, resulting in closed eye diagrams and untestable TDECQ performance. The superior performance of the GT-TF, in terms of TDECQ, BER, and IL, demonstrates its advantages over conventional solutions.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A system, comprising:
a thin-film filter (TFF) multiplexer (MUX) configured to transmit a plurality of input channels over an optical fiber; and
a Gires-Tournois tunable filter (GT-TF) operably coupled to the TFF MUX, wherein:
the GT-TF comprises an etalon chip,
the etalon chip is configured with a single cavity,
the etalon chip comprises a heater and a thermistor,
the GT-TF comprises a high-reflective (HR) coating on a first side and an anti-reflective (AR) coating on a second side,
the GT-TF is configured to provide a dispersion compensation, for one or more input channels of the plurality of input channels, via a periodic dispersion spectrum,
the dispersion compensation is tunable, and
the TFF MUX, in combination with the GT-TF, is configured to provide coarse wavelength division multiplexing (CWDM).

2. The system of claim 1, wherein the system comprise a control circuit configured to monitor one or more output parameters of the GT-TF.

3. The system of claim 2, wherein:
the one or more output parameters comprise ambient temperature, and
the heater and the thermistor are configured to adjust according to the ambient temperature.

4. The system of claim 1, wherein the etalon chip is configured to introduce 0 dB insertion loss.

5. The system of claim 1, wherein the system comprises a collimator configured to introduce less than 0.5 dB insertion loss in a reflection path.

6. The system of claim 1, wherein the AR coating is configured to pass a percentage of a reflected power.

7. The system of claim 1, wherein the HR coating and AR coatings are configured to direct the one or more input channels.

8. The system of claim 1, wherein the GT-TF is operable with a free spectral range (FSR) of 220 GHz for a 200 Gb/s per lane application.

9. The system of claim 1, wherein the dispersion spectrum is configured to compensate for a peak dispersion value of up to ±27 ps/nm.

10. The system of claim 1, wherein the GT-TF is configured to improve a transmitter dispersion and eye closure quaternary (TDECQ) at a transmission distance of 10 km.

11. A method, the method comprising:
transmitting a plurality of wavelength channels, via a thin-film filter (TFF) multiplexer (MUX), over an optical fiber;
reflecting the plurality of wavelength channels through a Gires-Tournois tunable filter (GT-TF) comprising a single-cavity etalon chip comprising a high-reflective (HR) coating and an adjustable anti-reflective (AR) coating;
tuning a dispersion of the reflected channels according to a heater and a thermistor integrated on the etalon chip; and
compensating for the dispersion via a periodic dispersion spectrum.

12. The method of claim 11, wherein the periodic dispersion spectrum is configured to compensate for positive and negative dispersion values within a free spectral range (FSR).

13. The method of claim 12, wherein the FSR is 220 GHz for a 200 Gb/s per lane application.

14. The method of claim 11, wherein the method comprises:
calibrating the GT-TF by measuring a free spectral range (FSR) and insertion loss, and
adjusting the heater and the thermistor according to the calibration results.

15. The method of claim 11, wherein the etalon chip is configured to introduce 0 dB insertion loss.

16. The method of claim 11, wherein the AR coating is configured to allow selective channel transmission and reflection to compensate for the dispersion.

17. The method of claim 11, wherein the GT-TF is configured to compensate for a peak dispersion values of up to ±27 ps/nm.

18. The method of claim 11, wherein the GT-TF is configured to improve a bit error rate (BER) of a transmitted channel over a 10 km fiber.

19. The method of claim 11, wherein the TFF MUX comprises an HR coating and an AR coating configured to direct one or more input channels of the plurality of input channels to the GT-TF.

20. The method of claim 11, wherein the method comprises:
measuring the ambient temperature, and
adjusting the heater and/or the thermistor according to the ambient temperature.
